(19) United States
(12) Patent Application Publication
(10) Pub. No.: US 2008/0318151 A1
(43) Pub. Date: Dec. 25, 2008

(54) Preparation method of latex for toner and preparation method of toner from the same

(75) Inventors: Yoda Shin, Jung-gu (KR); Kyung Yol Yon, Seongnam-si (KR); Jun Young Lee, Seoul (KR); Tae Hoe Koo, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 12/149,895

(22) Filed: May 9, 2008

(30) Foreign Application Priority Data
Jun. 22, 2007 (KR) 10-2007-0061536

(51) Int. Cl. G03G 5/00

(52) U.S. Cl. 430/137.14

(57) ABSTRACT

A method for preparing latex for a toner includes heating a mixture of distilled deionized water and poly (ethylene glycol)-ethyl ether methacrylate (PEG-EEM) with stirring, adding a monomer mixture, 1-dodecanethiol and an ester wax to the mixture, dispersing the mixture with ultrasonic vibration, adding potassium persulfate (KPS) to the dispersion and allowing to react for 4 to 6 hours, and allowing the reaction mixture to cool with stirring. The dry toner prepared by the method enables easy control over the molecular weight of latex, has superior durability and excellent low-temperature fixation, contains a small amount of wastewater and is composed of small-diameter particles, thus being suitable for use in high-definition printers.

### CROSS-REFERENCE TO RELATED APPLICATION

This application claims the benefit under 35 U.S.C. § 119(a) of Korean Patent Application No. 2007-0061536, filed on Jun. 22, 2007 in the Korean Intellectual Property Office, the disclosure of which is incorporated herein by reference in its entirety.

### BACKGROUND OF THE INVENTION

1. Field of the Invention

The present invention relates to a method for preparing latex for a toner and to a method for preparing a toner from the latex. More particularly, the invention is directed to a process for producing a latex without the use of emulsifiers. The present invention relates to a method for preparing latex for a toner comprising: heating a mixture of distilled deionized water and poly(ethylene glycol)-ethyl ether methacrylate (PEG-EEM) with stirring; adding a monomer mixture, 1-dodecanethiol and an ester wax to the mixture, dispersing the mixture with ultrasonic vibration, adding potassium persulfate (KPS) to the dispersion and allowing to react for 4 to 6 hours; and allowing the reaction mixture to cool with stirring. Alternatively, the method may comprise: heating a mixture of distilled deionized water and a compound of Formula 1 with stirring; adding a monomer mixture to the mixture and polymerizing the mixture with a 340 nm UV lamp for 6 hours; and cooling the reaction mixture with stirring. Furthermore, the present invention relates to a method for preparing toner particles comprising: adding deionized water to core latex, followed by stirring; adding a pigment solution to the reaction mixture; adjusting the pH of the mixture to a predetermined level, adding an aggregating agent to the mixture, followed by heating; allowing to react for 2 to 4 hours, adding NaCl to the reaction mixture and allowing to react for 2 hours; adding shell latex to the reaction mixture and adjusting pH of the mixture to a predetermined level and allowing to react; and cooling the reaction mixture to a temperature lower than a glass transition temperature, filtering to separate toner particles and drying.

2. Description of the Related Art

In conventional emulsion-aggregation (EA) polymerization processes, a wax dispersion and a pigment dispersion are separately prepared using an ionic surfactant (a cationic surfactant commonly used). A polymeric latex prepared using a surfactant is dispersed in a blend of the wax and pigment dispersions and particles in the resulting dispersion are induced to aggregate to prepare toner particles.

However, the toner prepared in accordance with such a process has a problem in that tribo charge is greatly affected by environmental factors, in particular, moisture and temperature. For example, adhesive force (or fixability) between a paper and a toner is decreased under the condition of high moisture. This problem is caused by the residue of a surfactant which is used to prepare EA toners.

In an attempt to solve the problem, the remaining surfactant may be washed in a washing process. However, the washing to thoroughly remove the surfactant involves the use of a large volume of wastewater, thus being undesirable in view of the environment and production costs.

### SUMMARY OF THE INVENTION

In attempts to solve the problems, an aspect of the present invention is to provide a method for preparing a toner without using any surfactant as an emulsifying agent.

One aspect of the invention is to provide a process for producing a toner where a macromonomer is used in the latex polymerization process to avoid the need for the use of an emulsifying agent in an aggregation step.

Therefore, in accordance with one aspect of the invention, a method for preparing latex for a toner is provided comprising: heating a mixture of distilled deionized water and poly(ethylene glycol)-ethyl ether methacrylate (PEG-EEM) with stirring; adding a monomer mixture, 1-dodecanethiol and an ester wax to the mixture, dispersing the mixture with ultrasonic vibration, adding potassium persulfate (KPS) to the dispersion and allowing to react for about 4 to 6 hours; and cooling the reaction mixture with stirring.

In accordance with another aspect of the invention, there is provided a method for preparing latex for a toner comprising: heating a mixture of distilled deionized water and the compound of Formula 1 with stirring; adding a monomer mixture to the mixture and polymerizing the mixture with a 340 nm UV lamp for 6 hours; and cooling the reaction mixture with stirring.

In accordance with yet another aspect of the invention, a method for preparing toner particles is provided comprising: adding deionized water to a core latex, followed by stirring; adding a pigment solution to the reaction mixture; adjusting the pH of the mixture to a predetermined level, adding an aggregating agent to the mixture, followed by heating; allowing the mixture to react for 2 to 4 hours, adding NaCl to the mixture and allowing to react for 2 hours; adding a shell latex to the reaction mixture and adjusting pH of the mixture to a predetermined level and allowing to react; and cooling the reaction mixture to a temperature lower than a glass transition temperature, filtering to separate toner particles and drying.

These and other aspects of the invention will become apparent from the following detailed description of the invention in conjunction with the annexed drawings which disclose various embodiments of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view illustrating a polymerization process with a compound of Formula 1;

FIG. 2 is a SEM image of the core latex;

FIG. 3 is a block diagram illustrating a polymerization process of the shell layer latex;

FIG. 4 is a SEM image of the shell layer latex; and

FIGS. 5a and 5b are SEM images of a toner prepared in accordance with Example 1 of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The toner particles size and distribution thereof can be adjusted to a desired level by controlling the amount of an aggregating agent, stirring rate and stirring time in an aggregation process with the use of the latex prepared by the polymerization of the present invention. The toner particles with an improved particle size distribution enable preparation of a high-definition high-resolution toner as a high yield.

In accordance with the present invention, a macromonomer used as a comonomer in a latex polymerization process maintains the stability of the latex, thus eliminating the necessity of an emulsifying agent for the aggregation process.

The macromonomer is amphiphilic (having both hydrophilic and hydrophobic properties) and is a polymer or oligomer which has a terminal polymerizable group. The hydrophilic moiety of the macromonomer chemically bound to particle surfaces enhances long-term stability of particles in an aqueous medium via steric stabilization. The variation in the amount of macromonomer used enables control over the particle size of the latex. Controlling the molecular weight of the macromonomer determines the shape of the final toner particles.

In accordance with the present invention, a toner is prepared by performing aggregation and coalescence processes without using any emulsifying agent at temperatures higher than a glass transition temperature (Tg) of the latex under controlled conditions of pH and electrolyte (inorganic salts) concentration. The size of the toner particles is controlled by the amount of an aggregating agent, temperature, aggregation time and stirring rate.

At an initial stage of aggregation, the pH is adjusted to a desired level or inorganic salts (such as NaCl or MgCl₂) are added as an aggregating agent. In one embodiment; the pH is adjusted to about pH 11. As a result, latex particles comprising a pigment and a wax begin to aggregate. When an alkaline agent is added to increase the pH, particle surfaces are negatively or less positively charged. The negative charges of the latex particle surfaces are mainly attributed to macromonomer chains chemically bound to the surfaces, a sulfate group of KPS used as a polymerization initiator and an acid group-containing comonomer. When the latex particles have a relatively large negative charge, that is, a high acidity (pH) or large (absolute) zeta potential, they have a strong repulsive force therebetween, thus making it difficult to aggregate the latex particles. On the other hand, when the particles have a relatively small negative charge, they have poor dispersion stability, thus making it possible to aggregate the latex particles. When the concentration of inorganic salts is higher than a critical coagulation concentration (CCC), the electrostatic repulsive force between the particles are offset, latex particles are thus rapidly aggregated by Brownian motion thereof. On the other hand, when the concentration of inorganic salts is lower than CCC, latex particles are slowly aggregated. During aggregation, the size of latex particles is increased by the ion intensity thereof and collision therebetween. As the temperature elevates, a particle size increases and the Gibbs free energy of the latex polymer chains increases at a temperature of the latex Tg or higher, thus allowing latex particles to freely move. Accordingly, toner particles with an even surface are produced.

The shape of the toner particles can be controlled according to the temperature and aggregation time. The morphological difference between toner particles is caused by the interfacial force therebetween and viscous chain mobility (Rheology) thereof. After toner particles with a desired size and shape are obtained, the particles are allowed to cool to a temperature lower than Tg. The toner particles are separated by filtration and dried. The resulting toner is subjected to external-treatment with silica or other external additives and the charge amount of the toner is adjusted to a desired level, to prepare a dry-toner for a laser printer.

The toner particles are produced from latex core particles and a shell-forming polymer. The latex core particles are produced from an aqueous mixture of a macromonomer, an ester wax, a chain transfer agent, and a monomer mixture. The monomer mixture typically includes one or more ethylenically unsaturated monomers. The monomer mixture is generally included in an amount of about 1 to 50 parts by weight based on the total weight of the toner composition. The ester wax can be any suitable ester wax commonly used in toner particles as known in the art. The ester wax can be included in an amount of about 1-20 parts by weight based on the weight of the monomer components of the core latex. The reaction mixture is dispersed by ultrasonic energy using an ultrasonic mixing apparatus. A polymerization initiator, such as potassium persulfate, is added to the dispersion which is allowed to react to form core particles.

The macromonomer can be selected from various macromonomers as known in the art that are commonly used in toner particles. In one embodiment of the invention, the macromonomer is a polyethyleneglycol ethyl ether methacrylate. The macromonomer has a hydrophobic group, a hydrophilic group and a reactive group. Examples of other macromonomers can include polyethylene glycol methacrylate, polyethylene glycol dimethacrylate, polyethylene glycol-modified urethane, polyethylene glycol-modified polyester, polyacylamide, polyethylene glycol hydroxyethylmethacrylate, hexa functional polyester acrylate, dendritic polyester acrylate, carboxy polyester acrylate, fatty acid modified acrylate and polyester methacrylate. The macromonomer is generally included in an amount of about 1 to 50 parts by weight based on the total weight of the toner composition.

The core forming latex particles are mixed with a pigment solution. The pH is then adjusted to a level sufficient to aggregate the core particles. Typically, the pH is adjusted to about pH 11. The mixture is heated to produce the polymerization reaction. The shell forming latex is combined with a dispersion of the core latex particles and pigment. The pH of the mixture is adjusted to aggregate and form the toner particles. The pH of the mixture of the core particles and the shell forming latex is generally at pH 11. The pigment can be carbon black, yellow, magenta and cyan colorants as known in the art. The colorant can be included in an amount of about 0.1-10 parts by weight based on the total weight of the monomer components of the core latex.

The shell of the toner is formed from a compound of Formula 1 and at least one ethylenically unsaturated monomer. Generally, the shell is formed from a mixture of ethylenically unsaturated monomers. Examples of suitable monomers are vinyl based monomers including monomers having a styrene-based repeating unit such as styrene and methyl styrene, (meth)acrylate based repeating units such as methyl (meth)acrylate and ethyl (meth)acrylate, and olefin based repeating units such as ethylene and propylene.

Synthesis of Latex for Core Particles of a Toner

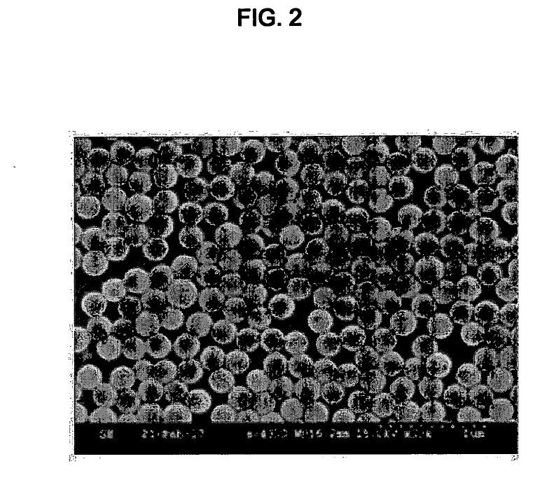

A mixture of deionized distilled water 470 g and poly (ethylene glycol)-ethyl ether methacrylate 5.0 wt % with respect to the total weight of a monomer mixture (PEG-EEM, available from Aldrich) are fed into a 1 L reactor with nitrogen gas-purging. The mixture is heated with stirring at 250 rpm. A solution is prepared at about 60° C., which comprises: a monomer mixture (10 g) consisting of styrene monomer 75 wt %, a butyl acrylate monomer and methacrylic acid monomer 2 wt %; 1-dodecanethiol 3.5 wt % as a chain transfer agent; and an ester wax 20 g. The solution is added to the reaction mixture. The resulting mixture is dispersed with ultrasonic vibration for about 5 min and fed into the reactor. When the internal temperature of the reactor reaches 82° C., a solution of potassium persulfate (KPS) 2.0 g as a water-soluble free radical initiator in deionized distilled water 50 g is fed into the reactor. The mixture is allowed to react for about 4 to 6 hours. After completion of the reaction, the reaction mixture is allowed to cool with stirring. The size of toner latex particles thus obtained is 200 nm and a yield thereof is nearly 100% (See FIG. 2).

The monomer components, chain transfer agent and ester wax are dispersed without the use of surfactants or dispersing agents. The dispersion is produced using an ultrasonic mixing apparatus that operates at a frequency sufficient to disperse the components.

Synthesis of Latex for Shell Layer

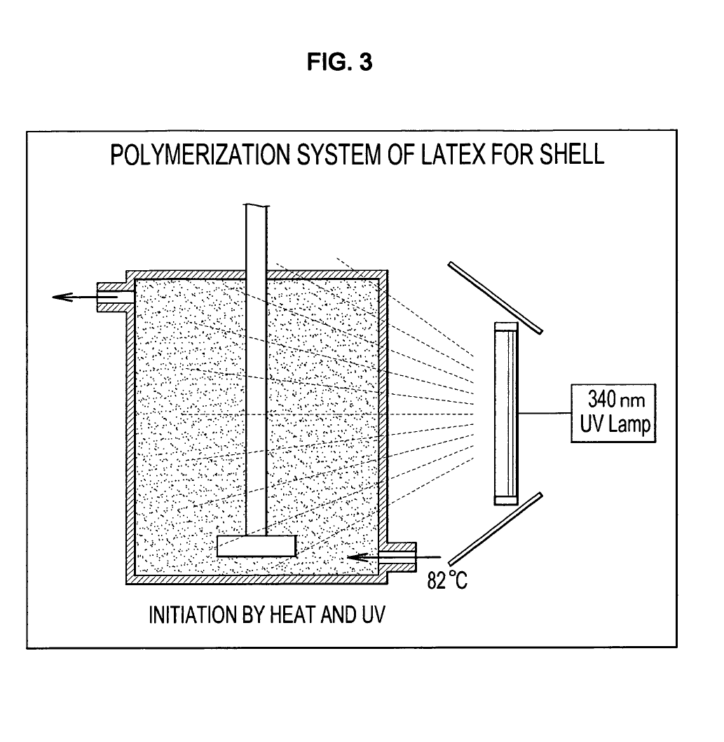

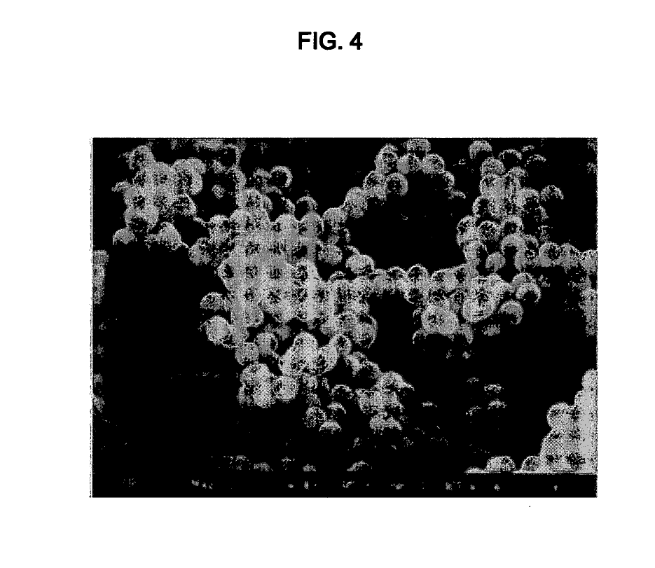

A mixture of distilled deionized water 470 g and diethylthiocarbonylsulfanylmethyl benzoic acid 2 g is fed into a 1 L reactor with nitrogen gas-purging. The mixture is heated with stirring at 300 rpm. When the internal temperature of the reactor reaches to 82° C., a monomer mixture (10 g) consisting of styrene monomer 75 wt %, a butyl acrylate monomer and methacrylic acid monomer 2 wt % is added dropwise thereto. The resulting mixture is polymerized with the use of a 340 nm UV lamp (See FIG. 3). The mixture is allowed to react for about 6 hours. After completion of the reaction, the reaction mixture is allowed to cool with stirring. The size of toner latex particles thus obtained is 200 nm and a yield thereof is nearly 100% (See FIG. 4).

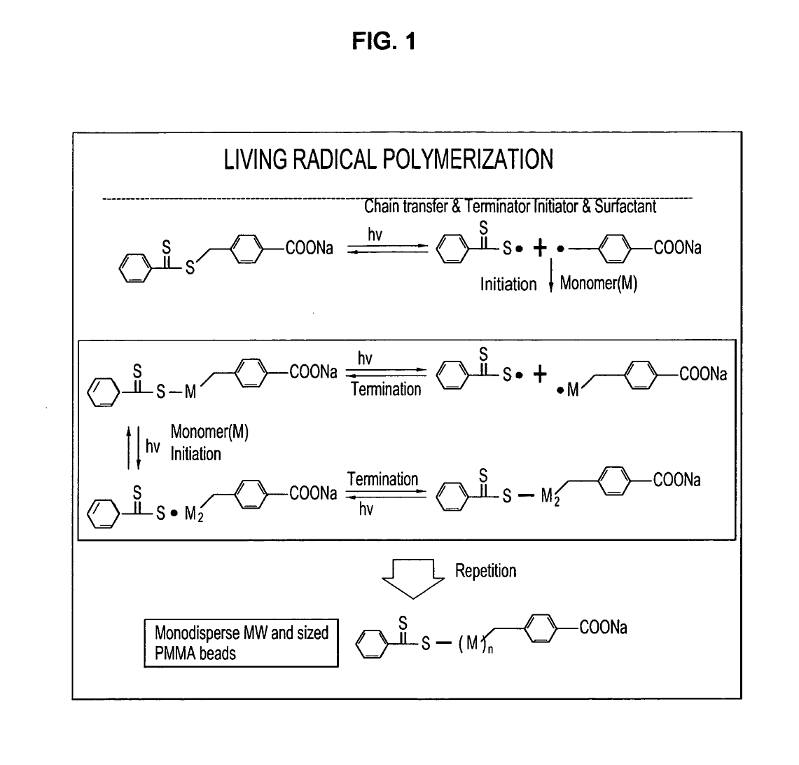

4-diethylthiocarbonylsulfanylmethyl benzoic acid used herein is represented by the following Formula 1 and a specific initiator for living radical polymerization which has multi-functions as a surfactant, an initiator and a chain transfer agent (See FIG. 1).

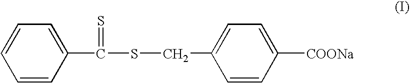

Living radical polymerization is a polymerization reaction that maintains polymerization activity for a considerable length of time even after polymerization by which the polymerization includes only initiation and growth reactions, but includes no chain transfer and terminal reactions. In general polymerizations, a growth reaction speed is higher than an initial reaction speed. On the other hand, in living radical polymerization, an initial reaction speed is higher than a growth reaction speed. In addition, living radical polymerization has advantages in that the concentration of growth species is maintained during polymerization, the molecular weight thereof thus increases in proportion to an increase in a polymerization yield and a molecular weight distribution thereof is narrow, enabling free control over the molecular weight.

Aggregation and Preparation of Toner

316 g of deionized distilled water and 307 g of (styrene)-(n-butyl acrylate)-(methacrylic acid)-(poly ethylene glycol-ethyl ether methacrylate) as a wax-containing latex polymer for a core are fed into a 1 L reactor and stirred at 350 rpm. 30 g of a pigment solution, in which macromonomers are dispersed, is added to the reaction mixture with stirring. After the pH is adjusted to 11, NaCl, MgCl₂.8H₂O or [Al₂(OH)ₙCl₆₋ₙ]ₘ as an aggregating agent is added thereto and gradually heated to 95° C. The resulting mixture is allowed to react at 95° C. for about 2 to 4 hours. NaCl is added to the reaction mixture and allowed to react for about 2 hours. After the pH of the reaction mixture is adjusted to 11, 50 to 200 g (depending upon a desired thickness of shell) of latex for a shell layer is added thereto. The reaction is allowed to proceed until the latex particles have a desired size and shape. Then, the latex is allowed to cool to a temperature lower than a glass transition temperature (Tg) of the latex, toner particles are separated by filtration and dried. The toner is subjected to external treatment with the use of silica and other external additives and the charge amount is controlled to prepare a final dry-toner for a laser printer.

### EXAMPLES

### Example 1

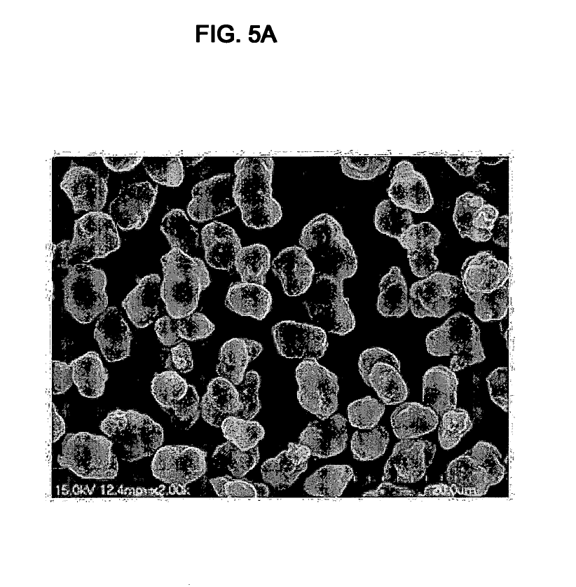

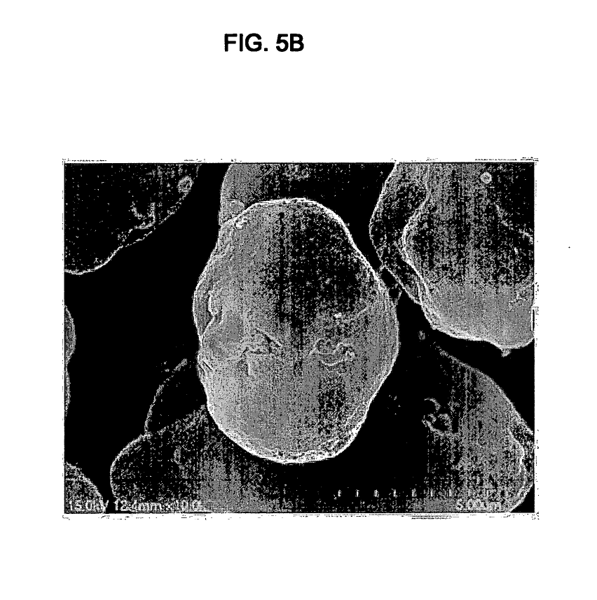

316 g of deionized distilled water and 307 g of wax-containing (styrene)-(n-butyl acrylate)-(methacrylic acid)-(poly ethylene glycol-ethyl ether methacrylate) copolymer as the core latex prepared in the latex preparation process were fed into a 1 L reactor and stirred at 350 rpm. 30 g of a pigment solution, in which macromonomers are dispersed, was added to the reaction mixture with stirring. After the pH was adjusted to 11, 30 g of MgCl₂ was added thereto and gradually heated to 95° C. After the resulting mixture was allowed to react at 95° C. for 2 hours, NaCl was added thereto and allowed to react for 2 hours. 50 g of latex for forming a shell layer was added to the mixture and allowed to react for 6 hours. Then, the latex was allowed to cool to a temperature lower than a glass transition temperature (Tg) of the latex, toner particles were separated by filtration and dried. The shape of toner thus prepared was in a potato-like sphere and the size (average volume) thereof was about 6.8 microns (See FIGS. 5a and 5b).

As apparent from the above description, the method of the present invention has advantages as follows. The molecular weight and Tg of latex for a core can be adjusted to a desired level by controlling the amount of macromonomers or chain transfer agents, or the content ratio of monomers in a polymerization process. The macromonomers that can be used instead of an emulsifying agent have a bulky molecular structure, thus affecting polymerization speed. Control over the content of macromonomers enables control of the molecular weight and Tg of the core latex. The molecular weight and Tg of the latex for a shell layer can be controlled by polymerization yield and initiator content. Monodisperse latex with a particle size distribution can be prepared without using any emulsifying agent.

In addition, no use of any emulsifying agent minimizes washing of toner, thus enabling simplification of the overall preparation process and thus reduction in preparation costs of polymerized toner. Furthermore, the amount of wastewater discharged is decreased, thus being advantageous in view of the environment. In addition, it is possible to solve problems associated with the use of emulsifying agents, e.g., high sensitivity to high moisture, low electrostatic voltage, dielectric loss, and aging and deterioration in toner flow, and furthermore to significantly improve stability of toner.

An excellent-distribution small particle-size toner as a high yield can be prepared in a simple manner. Furthermore, an improved-definition low-temperature fixation toner can be realized which is suitable for use in high-speed printers.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method for preparing latex for a toner comprising:
heating a mixture of distilled deionized water and poly(ethylene glycol)-ethyl ether methacrylate (PEG-EEM) with stirring;
adding a monomer mixture, 1-dodecanethiol and an ester wax to the mixture, dispersing the mixture with ultrasonic vibration, adding potassium persulfate (KPS) to the dispersion and allowing to react for about 4 to 6 hours; and
cooling the reaction mixture with stirring.

2. A method for preparing latex for a toner comprising:
heating a mixture of distilled deionized water and a compound represented by the following Formula 1 with stirring; 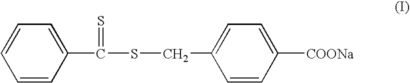
adding a monomer mixture to the stirred mixture, followed by polymerizing with a 340 nm UV lamp for about 6 hours; and
cooling the reaction mixture with stirring.

3. The method according to claim 2, wherein the monomer mixture includes a styrene monomer, a butyl acrylate monomer and a methacrylic acid monomer.

4. The method according to claim 2, wherein the monomer mixture includes 75% by weight of a styrene monomer and 2% by weight of a methacrylic acid monomer based on the total weight of the monomer mixture.

5. The method according to claim 1, wherein the mixture further comprises a monomer mixture having a butyl acrylate monomer, about 75% by weight of a styrene monomer and about 2% by weight of a methacrylic acid monomer based on the total weight of the monomer mixture.

6. A method for preparing a core latex for a toner comprising:
feeding a mixture of about 470 g of distilled deionized water and about 5.0 wt % of poly(ethylene glycol)-ethyl ether methacrylate (PEG-EEM) with respect to the total weight of a monomer mixture into a reactor, followed by heating with stirring at about 250 rpm;
preparing a solution of: about 100 g of a monomer mixture consisting of about 75 wt % of a styrene monomer, about 2 wt % of a methacrylic acid monomer and a butyl acrylate monomer; about 3.5 wt % of 1-dodecanethiol; and about 20 g of an ester wax at 60° C., adding the solution to the reaction mixture, and dispersing the mixture by ultrasonic vibration,
adding a solution of about 2.0 g of potassium persulfate (KPS) in about 50 g of deionized water to the reaction mixture when the internal temperature of the reactor reaches about 82° C. and allowing to react for about 4 to 6 hours; and
cooling the reaction mixture with stirring.

7. A method for preparing a shell-forming latex for a toner comprising:
feeding a mixture of about 470 g of distilled deionized water and about 2 g of a compound represented by the following Formula 1 into a reactor, followed by heating with stirring at about 300 rpm; 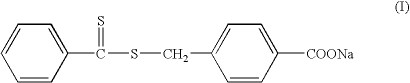
adding dropwise about 100 g of a monomer mixture consisting of about 75 wt % of a styrene monomer, about 2 wt % of a methacrylic acid monomer and a butyl acrylate monomer, when the internal temperature of the reactor reaches about 82° C., followed by polymerizing with a 340 nm UV lamp for about 6 hours; and
cooling the reaction mixture with stirring.

8. A method for preparing toner particles comprising:
adding deionized water to the latex prepared according to claim 1, followed by stirring to form a first reaction mixture;
adding a pigment solution to the first reaction mixture;
adjusting the pH of the first reaction mixture to a predetermined level, adding an aggregating agent to the reaction mixture, followed by heating;
allowing the first reaction mixture to react for about 2 to 4 hours, adding NaCl to the first reaction mixture and allowing to react for about 2 hours;
adding a shell-forming latex to form a second reaction mixture and adjusting the pH to a predetermined level and allowing to react; and
cooling the resulting mixture to a temperature lower than a glass transition temperature of the latex, filtering to separate toner particles and drying.

9. The method of claim 8, wherein the shell-forming latex is prepared by producing an aqueous mixture of the compound of Formula 1 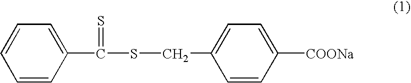
and monomer mixture; and
irradiating the mixture with UV radiation to polymerize the monomer mixture.

10. The method of claim 9, wherein
the aqueous mixture comprises distilled deionized water; and
where the monomer mixture is irradiated by said UV radiation at a wavelength of about 340 nm for about 6 hours.

11. The method of claim 9, wherein the monomer mixture comprises a butyl acrylate monomer, about 75 wt % of a styrene monomer, and about 2 wt % of a methacrylic acid monomer based on the total weight of the monomer mixture.

12. The method of claim 8, wherein the pH of the reaction mixture is adjusted to about pH 11.

13. The method of claim 8, wherein the first reaction mixture is heated gradually to a temperature of about 95° C.

14. The method of claim 8, wherein the aggregating agent is selected from the group consisting of NaCl, MgCl₂.8H₂O or [Al₂(OH)ₙCl₆₋ₙ]ₘ.

15. A method for preparing toner particles comprising:
adding deionized water to the latex prepared according to claim 6, followed by stirring to form a first reaction mixture;
adding a pigment solution to the first reaction mixture;
adjusting the pH of the first reaction mixture to a predetermined level, adding an aggregating agent to the first reaction mixture, followed by heating;
allowing the first reaction mixture to react for about 2 to 4 hours, adding NaCl to the resulting reaction mixture and allowing to react for about 2 hours;
adding a shell-forming latex to form a second reaction mixture and adjusting the pH of the second reaction mixture to a predetermined level and allowing the second reaction mixture to react; and
cooling the resulting mixture to a temperature lower than a glass transition temperature of the latex, filtering to separate toner particles and drying.

16. The method according to claim 15, wherein pH of the mixture is adjusted to 11.

17. The method according to claim 15, wherein heating of the mixture is gradually carried out to 95° C.

18. The method according to claim 15, wherein the aggregating agent is selected from the group consisting of NaCl, MgCl₂.8H₂O and [Al₂(OH)ₙCl₆₋ₙ]ₘ.

19. The method of claim 15, wherein
the shell-forming latex is prepared by forming an aqueous mixture of a compound of Formula 1 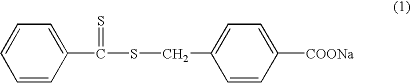
and a monomer mixture; and
irradiating the resulting mixture with UV radiation to polymerize the mixture.

20. The method of claim 19, wherein
the aqueous mixture comprises a butyl acrylate monomer, about 75 wt % of a styrene monomer, about 2 wt % of a methacrylic acid monomer and distilled deionized water based on the total weight of the monomer mixture.

21. The method of claim 20, wherein the mixture is irradiated by UV radiation at a wavelength of about 340 nm for about 6 hours.
